(19) United States
(12) Patent Application Publication
(10) Pub. No.: US 2006/0133977 A1
(43) Pub. Date: Jun. 22, 2006

(54) Catalyst system and method for the reduction of NOx

(76) Inventors: Jonathan Lloyd Male, Schoharie, NY (US); Grigorii Lev Soloveichik, Latham, NY (US); Alison Liana Palmatier, Porter Corners, NY (US); Teresa Grocela Rocha, Clifton Park, NY (US); Dan Hancu, Clifton Park, NY (US); Gregory Lee Warner, Schenectady, NY (US); Jennifer Kathleen Redline, Schenectady, NY (US); Eric George Budesheim, Wynantskill, NY (US); Kaidong Chen, Albany, CA (US); Stanlee Teresa Buddle, Gloversville, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/022,901

(22) Filed: Dec. 22, 2004

(51) Int. Cl. B01D 53/56

(52) U.S. Cl. 423/239.1; 502/347

(57) ABSTRACT

A catalyst system for the reduction of NOₓ comprises a catalyst comprising a metal oxide catalyst support, a catalytic metal oxide comprising at least one of gallium oxide or silver oxide, and at least one promoting metal selected from the group consisting of silver, cobalt, molybdenum, tungsten, indium and mixtures thereof. The catalyst system further comprises a gas stream comprising an organic reductant comprising oxygen. A method for reducing NOₓ utilizing the said catalyst system is also provided.

### BACKGROUND OF THE INVENTION

This invention relates generally to a catalyst system and method for the reduction of nitrogen oxide emissions and more particularly to a catalyst system that comprises a multi-component catalyst and a reductant.

Methods have long been sought to reduce the deleterious effects of air pollution caused by byproducts resulting from the imperfect high-temperature combustion of organic materials. When combustion occurs in the presence of excess air and at high temperatures, harmful byproducts, such as nitrogen oxides, commonly known as NOₓ, are created. NOₓ and subsequent derivatives have been suggested to play a major role in the formation of ground-level ozone that is associated with asthma and other respiratory ailments. NOₓ also contributes to soot formation, which is linked to a number of serious health effects, as well as to acid rain and the deterioration of coastal estuaries. As a result, NOₓ emissions are subject to many regulatory provisions limiting the amount of NOₓ that may be present in effluent gas vented into the surrounding environment.

One known method for dealing with NOₓ involves the use of selective catalytic reduction (SCR) to reduce NOₓ to nitrogen gas (N₂) using ammonia (NH₃) as a reductant. However, as ammonia's own hazardous consequences are well known, the use of NH₃ in an SCR system presents additional environmental and other problems that must also be addressed. As regulatory agencies continue to drive limits on NOₓ emission lower, other regulations are also driving down the permissible levels of NH₃ that may be emitted into the atmosphere. Because of regulatory limits on ammonia slip, the use of hydrocarbons and their oxygen derivatives for NOₓ reduction in an SCR process is very attractive. Numerous catalysts have been suggested for this purpose including zeolites, perovskites, and metals on metal oxide catalyst support. However, existing catalyst systems have either low activity or narrow region of working temperatures or low stability to water, which are detrimental to practical use. U.S. Pat. No. 6,703,343 teaches catalyst systems for use in NOₓ reduction. However, these catalyst systems require a specially synthesized metal oxide catalyst support with very low level of impurities. Therefore there is a need for an effective catalyst system to reduce NOₓ emissions, which system is stable and operable at a wide range of temperatures.

### BRIEF DESCRIPTION OF THE INVENTION

The present inventors have identified catalyst systems that are surprisingly effective using commercially available metal oxide catalyst supports with common impurities present. Thus, in one embodiment the present invention is a catalyst system for the reduction of NOₓ, which catalyst system comprises a catalyst comprising a metal oxide catalyst support, a catalytic metal oxide comprising at least one of gallium oxide or silver oxide, and at least one promoting metal selected from the group consisting of silver, cobalt, molybdenum, tungsten, indium and mixtures thereof. The catalyst system further comprises a gas stream comprising an organic reductant comprising oxygen.

Another embodiment of the present invention is a catalyst system for the reduction of NOₓ, which catalyst system comprises a catalyst comprising (i) a metal oxide catalyst support comprising alumina, (ii) at least one of gallium oxide or silver oxide present in an amount in the range of from about 5 mole % to about 31 mole %; and (iii) a promoting metal or a combination of promoting metals present in an amount in the range of from about 1 mole % to about 22 mole % and selected from the group consisting of silver; cobalt; molybdenum; tungsten; indium and molybdenum; indium and cobalt; and indium and tungsten. The catalyst system further comprises a gas stream comprising (A) water in a range of from about 1 mole % to about 12 mole %; (B) oxygen in a range of from about 1 mole % to about 15 mole %; and (C) an organic reductant comprising oxygen and selected from the group consisting of methanol, ethyl alcohol, butyl alcohol, propyl alcohol, dimethyl ether, dimethyl carbonate and combinations thereof. The organic reductant and the NOₓ are present in a carbon:NOₓ molar ratio from about 0.5:1 to about 24:1.

In yet another embodiment the present invention is a method for reducing NOₓ, which comprises the steps of: providing a gas mixture comprising NOₓ and an organic reductant comprising oxygen; and contacting the gas mixture with a catalyst. The catalyst comprises a metal oxide catalyst support, a catalytic metal oxide comprising at least one of gallium oxide or silver oxide and at least one promoting metal selected from the group consisting of silver, cobalt, molybdenum, tungsten, indium and mixtures thereof.

In yet another embodiment the present invention is a method for reducing NOₓ, which comprises the steps of: providing a gas stream comprising (A) NOₓ; (B) water from about 1 mole % to about 12 mole %; (C) oxygen from about 1 mole % to about 15 mole %; and (D) an organic reductant comprising oxygen selected from the group consisting of methanol, ethyl alcohol, butyl alcohol, propyl alcohol, dimethyl ether, dimethyl carbonate and combinations thereof; and contacting said gas stream with a catalyst comprising (i) a metal oxide catalyst support comprising at least one member selected from the group consisting of alumina, titania, zirconia, silicon carbide, and ceria; (ii) at least one of gallium oxide or silver oxide in the range of from about 5 mole % to about 31 mole %; and (iii) a promoting metal or a combination of promoting metals in the range of from about 1 mole % to about 22 mole % and selected from the group consisting of silver; cobalt; molybdenum; tungsten; indium and molybdenum; indium and cobalt; and indium and tungsten; wherein said organic reductant and said NOₓ are present in a carbon:NOₓ molar ratio from about 0.5:1 to about 24:1; and wherein said contact is performed at a temperature in a range of from about 100° C. to about 600° C. and at a space velocity in a range of from about 5000 hr⁻¹ to about 100000 hr⁻¹.

Various other features, aspects, and advantages of the present invention will become more apparent with reference to the following description and appended claims.

### DETAILED DESCRIPTION OF THE INVENTION

In the following specification and the claims, which follow, reference will be made to a number of terms which shall be defined to have the following meanings. The singular forms “a”, “an” and “the” include plural referents unless the context clearly dictates otherwise.

In one embodiment the present invention comprises a catalyst system for the selective reduction of NOₓ, which catalyst system comprises a catalyst and a reductant. The catalyst comprises a metal oxide catalyst support, a catalytic metal oxide, and a promoting metal. The reductant comprises an organic compound comprising oxygen.

The metal oxide catalyst support may comprise alumina, titania, zirconia, ceria, silicon carbide or any mixture of these materials. Typically, the metal oxide catalyst support comprises gamma-alumina with high surface area comprising impurities of at least about 0.2% by weight in one embodiment and at least about 0.3% by weight impurities in another embodiment. The metal oxide catalyst support may be made by any method known to those of skill in the art, such as co-precipitation, spray drying and sol-gel methods for example.

The catalyst also comprises a catalytic metal oxide. In one embodiment the catalytic metal oxide comprises at least one of gallium oxide or silver oxide. In a particular embodiment the catalyst comprises from about 5 mole % to about 31 mole % of gallium oxide. In another particular embodiment the catalyst comprises from about 12 mole % to about 31 mole % of gallium oxide. In still another particular embodiment the catalyst comprises from about 18 mole % to about 31 mole % of gallium oxide, wherein in all cases mole percent is determined by dividing the number of moles of catalytic metal by the total number of moles of the metal components in the catalyst, including the catalyst support and any promoting metal present. In another particular embodiment the catalyst comprises from about 0.5 mole % to about 31 mole % of silver oxide. In another particular embodiment the catalyst comprises from about 10 mole % to about 25 mole % of silver oxide. In still another particular embodiment the catalyst comprises from about 12 mole % to about 20 mole % of silver oxide, wherein in all cases mole percent is determined by dividing the number of moles of catalytic metal by the total number of moles of the metal components in the catalyst, including the metal components of the catalyst support and any promoting metal present.

The catalyst also comprises at least one promoting metal. The promoting metal may comprise at least one of silver, cobalt, molybdenum, tungsten or indium. Additionally, the promoting metal may also be a combination of more than one of these metals. The catalyst typically comprises from about 1 mole % to about 22 mole % of the promoting metal. In some embodiments the catalyst comprises from about 1 mole % to about 12 mole % of the promoting metal and in some other embodiments from about 1 mole % to about 7 mole % of the promoting metal. In one particular embodiment the catalyst comprises from about 1 mole % to about 5 mole % of the promoting metal. It should be appreciated that the term “promoting metal” is meant to encompass elemental metals, metal oxides or salts of the promoting metal, such as Co₂O₃ for example. In one particular embodiment wherein the catalytic metal oxide comprises silver oxide, the catalyst system must further comprise at least one promoting metal which is selected from the group consisting of cobalt, molybdenum, tungsten, indium, and mixtures thereof.

The catalysts may be produced by an incipient wetness technique, comprising the application of homogenous and premixed precursor solutions for catalytic metal oxide and promoting metal contacted with the metal oxide catalyst support. The metal oxide particles for the catalyst support are typically calcined before application of precursor solution. In some embodiments a primary drying step at about 80° C. to about 120° C. for about 1-2 hours is followed by the main calcination process. The calcination may be carried out at a temperature in the range of from about 500° C. to about 800° C. In some embodiments the calcination is carried out at a temperature in a range of from about 650° C. to about 725° C. In some embodiments the calcination is done for about 2 hours to about 10 hours. In some other embodiments the calcination is done for about 4 hours to about 8 hours. The particles are sifted to collect and use those which are from about 0.1 to about 1000 micrometers in diameter. In one embodiment the particle size ranges from about 2 micrometers to about 50 micrometers in diameter. Based on the surface area and total pore volume of the metal oxide catalyst support particles, the desired loading of the catalyst may then be calculated. As will be appreciated by those of ordinary skill in the art, the surface area and porosity may be up to about 20-30% lower in the final catalyst product, as a result of catalyst loading. The loading of the catalyst is determined by the total pore volume of the support, which is the volume of metal precursors that can be loaded by incipient wetness. The precursor loading is chosen such that the amount of metal is typically less than a monolayer of the active metal oxide on the metal oxide catalyst support. In some embodiments twice the pore volume is used as the total volume of precursor to load and the metal loading is taken in the range of from about 1 millimole to about 5 millimoles of the mixture of catalytic metal oxide and promoting metal per gram of metal oxide catalyst support.

In the subsequent steps of preparing the catalyst, precursor solutions of the catalytic metal oxide and, one or more promoting metals may be prepared. Precursor solutions may be prepared in aqueous media, in hydrophilic organic media, or in a mixture thereof. Hydrophilic organic media comprise carboxylic acids, alcohols and mixtures thereof such as, but not limited to, acetic acid or ethanol. The solutions are typically made by mixing solvent with metal salts, such as, but not limited to, metal nitrates, citrates, oxalates, acetylacetonates, molybdates, or benzoates, in an amount to create a solution of appropriate molarity based on the desired catalyst composition. In some embodiments the metal salt is a molybdenum heteropoly anion or ammonium molybdate. The methods used for preparing the catalyst system are known in the art and include depositing metal oxide catalyst support in a honey-comb support in a wash coating method or extruding in a slurry into a desired form. The purity of the metal precursors for both catalytic metal oxide and promoting metal is in the range of from about 95% to about 99.999% by weight. In one embodiment, all the metal precursors are mixed together and are as homogeneous as possible prior to addition to the metal oxide catalyst support. In some other embodiments different metal precursors are added sequentially to the metal oxide catalyst support. In one embodiment, the desired volume of the precursor solution is added to coat the metal oxide catalyst support and create a catalyst with the desired final catalyst loading. Once the metal salt solution or solutions have been added to the metal oxide catalyst support, the catalyst may optionally be left to stand for a period of time, in some embodiments about 6 to 10 hours. The catalyst is then dried for a period of time at a desired temperature. In a particular embodiment the catalyst may be dried under a vacuum, optionally while a nitrogen stream is passed over the mixture. Finally, the catalyst may be calcined at a desired temperature and for a desired time to create the final catalyst product.

Catalysts according to exemplary embodiments of the present invention may be created using either a manual or an automated process. Typically, a manual process is used for the preparation of catalysts of a larger mass, such as about 1 to about 20 grams (g) for example. An automated process is typically used when the catalysts are of a smaller mass, such as about 5 milligrams (mg) to about 100 mg, for example. Generally, manual and automated processes for preparation of the catalyst are similar with the exception that an automated process involves automated measuring and dispensing of the precursor solutions to the metal oxide catalyst support.

The reductant for use in the catalyst system of exemplary embodiments of the present invention comprises an organic compound comprising oxygen. Said organic compounds comprising oxygen are fluid, either as a liquid or gas, such that they may flow through the catalyst when introduced into an effluent gas stream for use in a catalyst system for the reduction of NOₓ. Typically, hydrocarbons comprising oxygen of less than about 16 carbon atoms will be fluid, although hydrocarbons comprising oxygen with higher numbers of carbon atoms may also be fluid, for example, depending on the chemical structure and temperature of the gas stream. The organic compounds comprising oxygen suitable for use as reductants typically comprise a member selected from the group consisting of an alcohol, an ether, an ester, a carboxylic acid, an aldehyde, a ketone, a carbonate and combinations thereof. In some embodiments the organic compounds comprising oxygen suitable for use as reductants comprise at least one functional group selected from the group consisting of hydroxy, alkoxy, carbonyl, carbonate and combinations thereof. Some non-limiting examples of organic compounds comprising oxygen suitable for use as reductants comprise methanol, ethyl alcohol, 1-butanol, 2-butanol, 1-propanol, iso-propanol, dimethyl ether, dimethyl carbonate and combinations thereof.

The catalyst system may be used in conjunction with any process or system in which it may be desirable to reduce NOₓ emissions, such as a gas turbine; a steam turbine; a boiler; a locomotive; or a transportation exhaust system, such as, but not limited to, a diesel exhaust system. The catalyst system may also be used in conjunction with systems involving generating gases from burning coal, burning volatile organic compounds (VOC), or in the burning of plastics; or in silica plants, or in nitric acid plants. The catalyst is typically placed at a location within an exhaust system where it will be exposed to effluent gas comprising NOₓ. The catalyst may be arranged as a packed or fluidized bed reactor, coated on a monolithic, foam, mesh or membrane structure, or arranged in any other manner within the exhaust system such that the catalyst is in contact with the effluent gas.

As will be appreciated by those ordinarily skilled in the art, although catalytic reactions are generally complex and involve many steps, the overall basic selective catalytic reduction reaction process for the reduction of NOₓ is believed to occur as follows:
NOₓ+O₂+organic reductant→N₂+CO₂+H₂O (1)

The effluent gas stream usually comprises air, water, CO, CO₂, NOₓ, and may also comprise other impurities. Additionally, uncombusted or incompletely combusted fuel may also be present in the effluent gas stream. The organic reductant is typically fed into the effluent gas stream to form a gas mixture, which is then fed through the catalyst. Sufficient oxygen to support the NOₓ reduction reaction may already be present in the effluent gas stream. If the oxygen present in the gas mixture is not sufficient for the NOₓ reduction reaction, additional oxygen gas may also be introduced into the effluent gas stream in the form of oxygen or air. In some embodiments the gas stream comprises from about 1 mole % to about 21 mole % of oxygen gas. In some other embodiments the gas stream comprises from about 1 mole % to about 15 mole % of oxygen gas.

One advantage of embodiments of the present invention is that the reduction reaction may take place in “reductant lean” conditions. That is, the amount of reductant added to the effluent gas to reduce the NOₓ is generally low. Reducing the amount of reductant to convert the NOₓ to nitrogen may provide for a more efficient process that has decreased raw material costs. The molar ratio of reductant to NOₓ is typically in a range of from about 0.25:1 to about 6:1. In other embodiments the ratio is typically such that the ratio of carbon atoms in the reductant is about 0.5 to about 24 moles per mole of NOₓ. In some other embodiments the organic reductant and the NOₓ are present in a carbon:NOₓ molar ratio in a range of from about 0.5:1 to about 15:1. In a particular embodiment the organic reductant and the NOₓ are present in a carbon:NOₓ molar ratio in a range of from about 0.5:1 to about 8:1.

The reduction reaction may take place over a range of temperatures. Typically, the temperature may range in one embodiment from about 100° C. to about 600° C., in another embodiment from about 200° C. to about 500° C. and in still another embodiment from about 350° C. to about 450° C.

The reduction reaction may take place under conditions wherein the gas mixture is configured to have a space velocity in one embodiment in a range of from about 5000 reciprocal hours (hr⁻¹) to about 100000 hr⁻¹, in another embodiment in a range of from about 8000 hr⁻¹ to about 50000 hr⁻¹ and in still another embodiment in a range of from about 8000 hr⁻¹ to about 40000 hr⁻¹.

Exemplary embodiments of the catalyst system may also advantageously be used in wet conditions. In particular embodiments NOₓ reduction accomplished using exemplary embodiments of the present invention may be effective in effluent gas streams comprising water. In some embodiments the gas stream comprises from about 1 mole % to about 12 mole % of water and in some other embodiments from about 2 mole % to about 10 mole % of water.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLES

Catalysts were prepared and used in combination with reductants in accordance with exemplary embodiments of the present invention. The conversion of the NOₓ was analyzed over a variety of experimental conditions, including varying catalyst compositions, reductants, reaction temperatures, and reductant to NOₓ ratios.

In the following examples catalyst samples were prepared each having a gamma-alumina catalyst support commercially available from Saint-Gobain NorPro of Stow, Ohio. The alumina catalyst support had a purity of 99.5% to 99.7%. The alumina support was first calcined at 725° C. for 6 hours in presence of an oxidant. The oxidant may be air or an oxidant gas comprising about 1% to about 21% of oxygen in nitrogen. The alumina particles were then sifted to collect catalyst support having a particle size diameter of from about 450 micrometers to about 1000 micrometers. Prior to loading, the catalyst support had a surface area of about 240 square meters per gram (m²/g) and a pore volume of 0.796 milliliters per gram (mL/g).

Gallium was used as the metal for the catalytic metal oxide added to the alumina. The gallium was added in a soluble form to wet the alumina support and was made from a solution of gallium nitrate having the formula Ga(NO₃)₃.6H₂O. The solution was made by combining deionized water with gallium nitrate having a purity of 99.999% (metals basis) obtained from Alfa-Aesar of Ward Hill, Mass. Millipore water having a resistivity of 18 megaohm-centimeters was employed in all operations. For the promoting metal an aqueous solution of the nitrate salt of the desired metal(s) also having a purity of 99.999% (metals basis) and obtained from Alfa-Aesar was added to the alumina support. All the metal precursors were mixed together and were as homogeneous as possible prior to addition to the alumina support. The catalysts were left to stand for 6 to 10 hours and were then dried under a dynamic vacuum with a nitrogen influx for 4 to 5 hours at 80° C. Finally, the dried catalyst was heat treated. The heat profile for this treatment began with an increase from 25° C. to 110° C. at 1.4° C. per minute. The catalyst was held at 110° C. for 1.5 hours, after which the temperature was ramped at 5° C. per minute to a value of 650° C. The catalyst was held 6 hours at this temperature and then allowed to cool over a period of about 4 to 6 hours.

Catalysts were tested in a 32-tube high-throughput heterogeneous catalyst-screening micro-reactor. The reactor was a heated, common headspace gas distribution manifold that distributed a reactant stream equally via matched capillaries to parallel reactor tubes. The manifold had heated capabilities, allowing pre-heating of the reactant stream and vaporization of liquid reactants prior to distribution. The entire heated manifold assembly was mounted on a vertical translation stage, raised and lowered via pneumatic pressure. Reactor tubes were inserted in a gold-coated 10 centimeter (cm) thick insulated copper reactor block (dimension 13.5 cm×25 cm), which was electrically heated to vary temperature between 200° C. to 650° C.

Chemically inert KALREZ™ o-rings available from DuPont of Wilmington, Del., served as viscoelastic end-seals on either end of each reactor tube. Reactor tubes were made of INCONEL 600™ tubing with 0.635 cm outside diameter and 0.457 cm internal diameter, available from Inco Alloys/Special Metals of Saddle Brook, N.J. The tubes were free to slide vertically through the gold-coated copper heating block. Each tube contained a quartz wool frit, on which the catalyst samples of about 0.050 g were placed in the center of each of the tubes through which a reactant stream of a blended gas mixture comprising NOₓ and reductant simulating an effluent gas stream was passed. A single bypass tube was used to ensure equal flow through each of the 32 testing tubes. The fittings were connected to a distribution manifold for delivery of the blended gas mixture. The components of the blended gas mixture were fed to a common mixing manifold using electronic mass flow controllers, and then routed to the distribution manifold. The pressure in the distribution manifold was maintained at about 275.8 kilopascals (kPa). Reactor temperature and flow control were fully automated.

Once loaded in the tubes, the catalysts were heat-treated under airflow as described herein above and then reacted with the blended gas mixture. The reactor effluent was sent to heated sampling valves that selected tubes in series and fed the continuous stream to a chemiluminescent analyzer. Any stream that was not routed to the analytical device was routed to a common vent.

Switching valves for routing gases were computer controlled and actuated in a pre-determined time-based sequence. The chemiluminescent analyzer was connected to a computer-based data-logging system. Data corresponding to reactor tube effluent composition were time-stamped and stored. Data from the bypass tube were also stored as a reference to the inlet composition of the catalyst reactor tubes. This permitted the combination of data to determine activity and selectivity of each catalyst sample.

For NOₓ reduction testing the reactant stream of the blended gas mixture comprised reductant, about 200 ppm NOₓ, 12% by volume oxygen, 7% by volume water and the balance nitrogen. The type and amount of reductant in the stream varied depending on the experiments being conducted. The flow rate of the blended gas mixture through each of the tubes was 33 standard cubic centimeters per minute (sccm) per tube.

Table 1 shows the compositions of the catalyst samples prepared, with compositions expressed in mole percent of each promoting metal and/or catalytic metal present in the catalyst. The balance of the composition was alumina from the alumina catalyst support. Mole percent was determined for each component by dividing the number of moles of that component by the total number of moles of the metal components in the catalyst, including the metal components of the metal oxide catalyst support. The abbreviation “C.Ex.” means Comparative Example. Comparative example 1 consists only of the alumina support.

TABLE 1

| Example | Ga | In | Ag | Co | Mo | W |
|---|---|---|---|---|---|---|
| C. Ex. 1 | 0 | 0 | 0 | 0 | 0 | 0 |
| C. Ex. 2 | 29 | 0 | 0 | 0 | 0 | 0 |
| C. Ex. 3 | 0 | 2 | 0 | 0 | 0 | 0 |
| C. Ex. 4 | 0 | 4 | 0 | 0 | 0 | 0 |
| C. Ex. 5 | 0 | 0 | 2 | 0 | 0 | 0 |
| C. Ex. 6 | 0 | 0 | 5 | 0 | 0 | 0 |
| C. Ex. 7 | 27 | 2 | 0 | 0 | 0 | 0 |
| Ex. 1 | 27 | 0 | 2 | 0 | 0 | 0 |
| Ex. 2 | 25 | 0 | 4 | 0 | 0 | 0 |
| Ex. 3 | 27 | 0 | 0 | 2 | 0 | 0 |
| Ex. 4 | 25 | 0 | 0 | 4 | 0 | 0 |
| Ex. 5 | 25 | 2 | 0 | 2 | 0 | 0 |
| Ex. 6 | 22 | 3 | 0 | 3 | 0 | 0 |
| Ex. 7 | 27 | 0 | 0 | 0 | 2 | 0 |
| Ex. 8 | 25 | 0 | 0 | 0 | 5 | 0 |
| Ex. 9 | 22 | 0 | 0 | 0 | 8 | 0 |
| Ex. 10 | 22 | 3 | 0 | 0 | 3 | 0 |
| Ex. 11 | 21 | 6 | 0 | 0 | 1 | 0 |
| Ex. 12 | 27 | 0 | 0 | 0 | 0 | 2 |
| Ex. 13 | 25 | 0 | 0 | 0 | 0 | 4 |
| Ex. 14 | 20 | 0 | 0 | 0 | 0 | 8 |
| Ex. 15 | 22 | 6 | 0 | 0 | 0 | 1 |
| Ex. 16 | 21 | 3 | 0 | 0 | 0 | 3 |

A first set of experiments was conducted in which various catalyst samples were prepared and tested with various reductants using the described testing procedure at 350° C. The results in Table 2 show the percentage of NOₓ converted for each of the catalyst systems. The example and comparative example numbers in Table 2 correspond to the catalyst compositions in the examples and comparative examples of Table 1. Although the molar ratio of reductant to NOₓ varied with the reductant used, the molar ratio of carbon:NOₓ was generally equal to about 2:1 for each of the experimental systems. The abbreviation “NBA” means 1-butanol.

TABLE 2

Reductants

| Example | MeOH | EtOH | i-PrOH | NBA |
|---|---|---|---|---|
| C. Ex. 1 | 12 | 35 | 30 | 35 |
| C. Ex. 2 | 18 | 32 | 33 | 31 |
| C. Ex. 3 | 29 | 35 | 28 | 33 |
| C. Ex. 4 | 26 | 34 | 43 | 32 |
| C. Ex. 5 | 6 | 24 | 66 | 42 |
| C. Ex. 6 | 7 | 14 | 36 | 21 |
| Ex. 1 | 12 | 59 | 97 | 55 |
| Ex. 2 | 2 | 14 | 30 | 19 |
| Ex. 3 | 15 | 34 | 31 | 30 |
| Ex. 4 | 43 | 56 | 25 | 46 |
| Ex. 5 | 42 | 46 | 28 | 41 |
| Ex. 6 | 34 | 39 | 33 | 39 |

As shown in Table 2, Example 1 having a combination of gallium oxide as a catalytic metal oxide and silver as a promoting metal showed particularly good results using reductants such as ethanol, iso-propanol and 1-butanol. Example 4 comprising gallium and cobalt showed good performance with methanol, ethanol and NBA. Examples 5 and 6 comprising cobalt, indium and gallium also showed good performance with methanol, ethanol, and 1-butanol.

A second set of experiments was conducted in which various catalyst samples were prepared and tested with various reductants using the described testing procedure at 400° C. The results in Table 3 show the percentage of NOₓ converted for each of the catalyst systems. The example and comparative example numbers in Table 3 correspond to the catalyst compositions identified in the examples and comparative examples of Table 1. Although the molar ratio of reductant to NOₓ varied with the reductant used, the molar ratio of carbon:NOₓ was generally equal to about 6:1 for each of the experimental systems. The abbreviations “DMC”, IPA”, and “NBA” mean dimethyl carbonate, iso-propyl alcohol, and 1-butanol, respectively.

TABLE 3

| | Catalyst Composition | | | | | | Reductant | | | | |
|---|---|---|---|---|---|---|---|---|---|---|---|
| Example | Ga | In | Ag | Co | Mo | W | MeOH | DMC | EtOH | IPA | NBA |
| C. Ex. 2 | 29 | 0 | 0 | 0 | 0 | 0 | 20 | 38 | 57 | 55 | 57 |
| C. Ex. 3 | 0 | 2 | 0 | 0 | 0 | 0 | 18 | 34 | 55 | 61 | 56 |
| C. Ex. 5 | 0 | 0 | 2 | 0 | 0 | 0 | 21 | 30 | 95 | 96 | 83 |
| C. Ex. 7 | 27 | 2 | 0 | 0 | 0 | 0 | 28 | 48 | 62 | 54 | 57 |
| Ex. 3 | 27 | 0 | 0 | 2 | 0 | 0 | 17 | 79 | 49 | 42 | 37 |
| Ex. 6 | 22 | 3 | 0 | 3 | 0 | 0 | 18 | 49 | 40 | 40 | 33 |
| Ex. 7 | 27 | 0 | 0 | 0 | 2 | 0 | 28 | 44 | 60 | 52 | 56 |
| Ex. 8 | 25 | 0 | 0 | 0 | 5 | 0 | 34 | 54 | 76 | 70 | 65 |
| Ex. 9 | 22 | 0 | 0 | 0 | 8 | 0 | 50 | 77 | 44 | 31 | 41 |
| Ex. 10 | 22 | 3 | 0 | 0 | 3 | 0 | 35 | 62 | 47 | 33 | 42 |
| Ex. 11 | 21 | 6 | 0 | 0 | 1 | 0 | 25 | 25 | 65 | 28 | 21 |
| Ex. 12 | 27 | 0 | 0 | 0 | 0 | 2 | 37 | 55 | 19 | 22 | 68 |
| Ex. 13 | 25 | 0 | 0 | 0 | 0 | 4 | 53 | 32 | 28 | 24 | 21 |
| Ex. 14 | 20 | 0 | 0 | 0 | 0 | 8 | 65 | 36 | 30 | 31 | 29 |
| Ex. 15 | 22 | 6 | 0 | 0 | 0 | 1 | 24 | 58 | 50 | 13 | 55 |
| Ex. 16 | 21 | 3 | 0 | 0 | 0 | 3 | 41 | 64 | 60 | 22 | 61 |

While all of the catalyst samples showed good or better performance compared with comparative examples, example 8 having 5 mole % molybdenum and 25 mole % gallium showed good results with all of the five oxygenated reductants. In general the catalyst systems in accordance with exemplary embodiments of the present method were successful in reducing some NOₓ in each case.

A third set of experiment was conducted in which methanol was tested as a reductant at 400° C. in presence of a gas mixture comprising 200 ppm NOₓ, 4% water, and 13% O₂ and the balance nitrogen at a nominal space velocity of 28,000 hr⁻¹. The catalyst compositions along with the catalyst activity for each experiment are given in Table 4. The balance of moles catalyst comprises the metal oxide catalyst support. Although the molar ratio of reductant to NOₓ varied with the reductant used, the molar ratio of carbon:NOₓ was generally equal to about 6:1 for each of the experimental systems. The catalyst activity is expressed in moles of NOₓ converted to N₂ per gram of catalyst per hour.

TABLE 4

| | Catalyst | | | Reductant |
|---|---|---|---|---|
| Example | Ga | Ag | In | MeOH |
| Ex. 17 | 6 | 6 | 19 | 5.2E−06 |
| Ex. 18 | 6 | 13 | 13 | 1.0E−05 |
| Ex. 19 | 6 | 19 | 6 | 1.6E−05 |
| Ex. 20 | 13 | 6 | 13 | 5.2E−06 |
| Ex. 21 | 0 | 19 | 13 | 2.0E−05 |
| Ex. 22 | 0 | 13 | 19 | 5.9E−07 |
| Ex. 23 | 29 | 2 | 0 | 8.4E−08 |
| Ex. 24 | 0 | 16 | 16 | 1.7E−05 |
| Ex. 25 | 9 | 11 | 11 | 1.1E−05 |
| Ex. 26 | 5 | 16 | 10 | 1.6E−5 |
| C. Ex. 8 | 31 | 0 | 0 | 6.3E−07 |

Various embodiments of this invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. Thus, it is intended that the present invention cover all suitable modifications and variations as come within the scope of the appended claims and their equivalents.

What is claimed is:

1. A catalyst system for the reduction of NOₓ comprising:
a catalyst comprising a metal oxide catalyst support, a catalytic metal oxide comprising at least one of gallium oxide or silver oxide, and at least one promoting metal selected from the group consisting of silver, cobalt, molybdenum, tungsten, indium and mixtures thereof; and
a gas stream comprising an organic reductant comprising oxygen.

2. The catalyst system of claim 1, wherein said metal oxide catalyst support comprises at least one member selected from the group consisting of alumina, titania, zirconia, ceria, silicon carbide and mixtures thereof.

3. The catalyst system of claim 1, wherein said catalytic metal oxide comprises gallium oxide in a range of from about 5 mole % to about 31 mole %.

4. The catalyst system of claim 1, wherein said catalytic metal oxide comprises gallium oxide in a range of from about 18 mole % to about 31 mole %.

5. The catalyst system of claim 1, wherein said catalytic metal oxide comprises silver oxide in the range of from about 0.5 mole % to about 31 mole %.

6. The catalyst system of claim 1, wherein said catalyst comprises said promoting metal in a range of from about 1 mole % to about 22 mole %.

7. The catalyst system of claim 1, wherein said catalyst comprises said promoting metal in a range of from about 1 mole % to about 7 mole %.

8. The catalyst system of claim 1, wherein the catalytic metal oxide comprises gallium oxide and the promoting metal comprises silver or the combination of indium and silver.

9. The catalyst system of claim 1, wherein the catalytic metal oxide comprises silver oxide and the promoting metal comprises of indium.

10. The catalyst system of claim 1, wherein said organic reductant is selected from the group consisting of an alcohol, an ether, an ester, a carboxylic acid, an aldehyde, a ketone, a carbonate and combinations thereof.

11. The catalyst system of claim 1, wherein said organic reductant is selected from the group consisting of methanol, ethyl alcohol, butyl alcohol, propyl alcohol, dimethyl ether, dimethyl carbonate and combinations thereof.

12. The catalyst system of claim 1, wherein said organic reductant and said NOₓ are present in a carbon:NOₓ molar ratio from about 0.5:1 to about 24:1.

13. The catalyst system of claim 1, wherein said organic reductant and said NOₓ are present in a carbon:NOₓ molar ratio from about 0.5:1 to about 8:1

14. The catalyst system of claim 1, wherein said gas stream further comprises water in a range of from about 1 mole % to about 12 mole %.

15. The catalyst system of claim 1, wherein said gas stream further comprises oxygen gas in a range of from about 1 mole % to about 21 mole %.

16. The catalyst system of claim 1, wherein NOₓ is present in effluent gas from a combustion source, said combustion source comprising at least one of a gas turbine, a boiler, a locomotive, a transportation exhaust system, coal burning, plastics burning, volatile organic compound burning, a silica plant, or a nitric acid plant.

17. A catalyst system for the reduction of NOₓ comprising:
a catalyst comprising (i) a metal oxide catalyst support comprising alumina, (ii) at least one of gallium oxide or silver oxide present in an amount in the range of from about 5 mole % to about 31 mole %; and (iii) a promoting metal or a combination of promoting metals present in an amount in the range of from about 1 mole % to about 22 mole % and selected from the group consisting of silver; cobalt; molybdenum; tungsten; indium and molybdenum; indium and cobalt; and indium and tungsten; and
a gas stream comprising (A) water in a range of from about 1 mole % to about 12 mole %; (B) oxygen in a range of from about 1 mole % to about 15 mole %; and (C) an organic reductant comprising oxygen and selected from the group consisting of methanol, ethyl alcohol, butyl alcohol, propyl alcohol, dimethyl ether, dimethyl carbonate and combinations thereof;
wherein said organic reductant and said NOₓ are present in a carbon:NOₓ molar ratio from about 0.5:1 to about 24:1.

18. A method for reducing NOₓ , which comprises the steps of:
providing a gas mixture comprising NOₓ and an organic reductant comprising oxygen; and
contacting said gas mixture with a catalyst, wherein said catalyst comprises a metal oxide catalyst support, a catalytic metal oxide comprising at least one of gallium oxide or silver oxide, and at least one promoting metal selected from the group consisting of silver, cobalt, molybdenum, tungsten, indium and mixtures thereof.

19. The method of claim 18, wherein said contact is at a temperature in a range of from about 100° C. to about 600° C.

20. The method of claim 18, wherein said contact is at a temperature in a range of from about 200° C. to about 500° C.

21. The method of claim 18, wherein said contact is performed at a space velocity in a range of from about 5000 hr⁻¹ to about 100000 hr⁻¹.

22. The method of claim 18, wherein said metal oxide catalyst support comprises at least one of alumina, titania, zirconia, silicon carbide or ceria.

23. The method of claim 18, wherein said catalytic metal oxide comprises gallium oxide in the range of from about 5 mole % to about 31 mole %.

24. The method of claim 18, wherein said catalyst comprises said promoting metal from about 1 mole % to about 22 mole %.

25. The method of claim 18, wherein said organic reductant is selected from the group consisting of an alcohol, an ether, an ester, a carboxylic acid, an aldehyde, a ketone, a carbonate and combinations thereof.

26. The method of claim 18, wherein said organic reductant is selected from the group consisting of methanol, ethyl alcohol, butyl alcohol, propyl alcohol, dimethyl ether, dimethyl carbonate and combinations thereof.

27. The method of claim 18, wherein said organic reductant and said NOₓ are present in a carbon:NOₓ molar ratio from about 0.5:1 to about 24:1.

28. The method of claim 18, wherein said gas stream comprises water from about 1 mole % to about 12 mole %.

29. The method of claim 18, wherein said gas stream comprises oxygen from about 1 mole % to about 21 mole %.

30. The method of claim 18, wherein NOₓ is present said effluent gas from a combustion source, said combustion source comprising at least one of a gas turbine, a boiler, a locomotive, a transportation exhaust system, coal burning, plastics burning, volatile organic compound burning, a silica plant, or a nitric acid plant.

31. A method for reducing NOₓ, which comprises the steps of:
providing a gas stream comprising (A) NOₓ ; (B) water from about 1 mole % to about 12 mole %; (C) oxygen from about 1 mole % to about 15 mole %; and (D) an organic reductant comprising oxygen selected from the group consisting of methanol, ethyl alcohol, butyl alcohol, propyl alcohol, dimethyl ether, dimethyl carbonate and combinations thereof; and
contacting said gas stream with a catalyst comprising (i) a metal oxide catalyst support comprising at least one member selected from the group consisting of alumina, titania, zirconia, silicon carbide, and ceria; (ii) at least one of gallium oxide or silver oxide in the range of from about 5 mole % to about 31 mole %; and (iii) a promoting metal or a combination of promoting metals in the range of from about 1 mole % to about 22 mole % and selected from the group consisting of silver; cobalt; molybdenum; tungsten; indium and molybdenum; indium and cobalt; and indium and tungsten;
wherein said organic reductant and said NOₓ are present in a carbon:NOₓ molar ratio from about 0.5:1 to about 24:1; and wherein said contact is performed at a temperature in a range of from about 100° C. to about 600° C. and at a space velocity in a range of from about 5000 hr⁻¹ to about 100000 hr⁻¹.
